(19) United States
(12) Patent Application Publication
(10) Pub. No.: US 2026/0037218 A1
(43) Pub. Date: Feb. 5, 2026

(54) RECONFIGURABLE BUTTERFLY ARCHITECTURE

(71) Applicant: Microsoft Technology Licensing, LLC, Redmond, WA (US)

(72) Inventors: Mojtaba BISHEH NIASAR, Durham, NH (US); Naga Kiranmayee UPADHYAYULA, Snohomish, WA (US)

(21) Appl. No.: 18/792,465

(22) Filed: Aug. 1, 2024

(51) Int. Cl. G06F 7/523

(52) U.S. Cl. CPC G06F 7/523

(57) ABSTRACT

Devices, systems, and methods for reconfigurable butterfly architectures are provided. A reconfigurable butterfly operator circuit includes a single multiplier configured to receive a first variable and a twiddle factor and produce a product, first and second modular subtractors coupled to the multiplier, the first modular subtractor coupled to receive input coefficients and provide a modular difference, and the second modular subtractor coupled to receive the product, a modular adder coupled to receive the input coefficients and provide a modular sum, and multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the circuit is configured as a Gentleman-Sande butterfly operator circuit or a Cooley-Tukey butterfly operator circuit.

### BACKGROUND

The advent of quantum computers poses a serious challenge to the security of the existing public-key cryptosystems, as they can be potentially broken based on Shor's algorithm. Lattice-based cryptosystems are among the most promising post-quantum cryptography (PQC) algorithms that are believed to be hard for both classical and quantum computers to break.

Number Theoretic Transform (NTT) and Inverse Number Theoretic Transform (INTT) can be used in a lattice-based PQC algorithm to reduce the computation cost of computing a polynomial multiplication. Modular multiplication is typically used in an NTT/INTT architecture.

### SUMMARY

A method, device, system, or a machine-readable medium for a reconfigurable butterfly architecture circuit are provided. A circuit can perform NTT and INTT operations. The circuit can perform point-wise mathematical operations. A control signal provided to multiplexers controls the operands provided to components of the circuit. The control signal thus controls the mode (e.g., NTT, INTT, point-wise multiplication, etc.) in which the circuit is configured.

A reconfigurable butterfly operator circuit includes a single multiplier configured to receive a first variable and a twiddle factor and produce a product. The circuit can include first and second modular subtractors coupled to the multiplier, the first modular subtractor coupled to receive input coefficients and provide a modular difference, and the second modular subtractor coupled to receive the product. The circuit can include a modular adder coupled to receive the input coefficients and provide a modular sum. The circuit can include multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the reconfigurable butterfly operator circuit is configured as a Gentleman-Sande (GS) butterfly operator circuit or a Cooley-Tukey (CT) butterfly operator circuit.

The circuit can further include a first bank of flip flops connected in series with each other, the first bank of flip flops coupled to delay an input coefficient of the input coefficients. The circuit can further include a second bank of flip flops connected in series of with each other, the second bank of flip flops coupled to delay the modular sum. The circuit can further include a third flip flop, the third flip flop coupled to delay a twiddle factor. The circuit can further include a modular reduction operator configured to determine a modulus of the product and provide the modulus of the product to the modular subtractor.

The multiplexers can include a first multiplexer coupled to receive the delayed input coefficient and the input coefficient. The multiplexers can include a second multiplexer coupled to receive the modular difference and a second input coefficient of the input coefficients. The multiplexers can include a third multiplexer coupled to receive the twiddle factor and the delayed twiddle factor. The multiplexers can include a fourth multiplexer coupled to receive output of the second modular subtractor and output of the modular reduction operator. The multiplexers can include a fifth multiplexer coupled to receive the modular sum and the modular sum delayed by a fourth bank of flip flops.

The circuit can further include a divide by two operator coupled to receive the modular difference, generate a quotient that is the modular difference divided by two, and provide the quotient to the modular reduction operator. The control signal can further select whether the multiplexers are in point-wise multiplication (PWM), point-wise addition (PWA), and point-wise subtraction (PWS) mode.

A method for operating a reconfigurable butterfly operator circuit can include providing, by a first modular subtractor and based on input coefficients, a modular difference. The method can further include providing, by a single multiplier and based on a first variable and a twiddle factor, a product. The method can further include receiving, by a second modular subtractor coupled to the multiplier, the product. The method can further include providing, by a modular adder and based on the input coefficients, a modular sum. The method can further include providing, by one or more multiplexers of the multiplexers, the input coefficients to the modular adder. The method can further include providing, by one or more of the multiplexers, the twiddle factor and the first variable to the multiplier. The method can further include receiving, by each of the multiplexers, a control signal that selects whether the reconfigurable butterfly operator circuit is configured as a Gentleman-Sande (GS) butterfly operator circuit or a Cooley-Tukey (CT) butterfly operator circuit.

The method can further include delaying, by a first bank of flip flops connected in series with each other, an input coefficient of the input coefficients. The method can further include delaying, by a second bank of flip flops connected in series of with each other, the modular sum. The method can further include providing, by a divide by two operator coupled to receive the modular difference, a quotient that is the modular difference divided by two to a modular reduction operator. The control signal can further select whether the multiplexers are in point-wise multiplication (PWM), point-wise addition (PWA), and point-wise subtraction (PWS) mode.

### BRIEF DESCRIPTION OF DRAWINGS

FIG. 1 illustrates, by way of example, a conceptual circuit diagram of an embodiment of a Cooley-Tukey (CT) butterfly operator circuit.

FIG. 2 illustrates, by way of example, a conceptual circuit diagram of an embodiment of a Gentleman-Sande (GS) butterfly operator circuit.

FIG. 3 illustrates, by way of example, a diagram of an embodiment of a circuit for performing modular addition and subtraction.

FIG. 4 illustrates, by way of example, a diagram of an embodiment of a reconfigurable butterfly architecture.

FIG. 5 illustrates, by way of example, a diagram of an embodiment of a circuit for performing modular addition in a modular reduction circuit of FIG. 6.

FIG. 6 illustrates, by way of example, a diagram of an embodiment of a circuit for modular multiplication in cryptography operations.

FIG. 7 illustrates, by way of example, a graph of a performance comparison (in units of operations performed/cycle).

FIG. 8 illustrates, by way of example, a circuit diagram of a circuit that is the reconfigurable butterfly architecture of FIG. 4 when in GS mode.

FIG. 9 illustrates by way of example, a graph of multiplications executed in performing INTT for butterfly operations and post-processing.

FIG. 10 illustrates, by way of example, a circuit diagram of an improved reconfigurable butterfly circuit in GS mode.

FIG. 11 illustrates, by way of example, a diagram of a circuit for polynomial multiplication in the NTT domain that reuses resources of the circuits of FIGS. 1 and 2.

FIG. 12 illustrates, by way of example, a diagram of an embodiment of a circuit architecture that includes PWM for key generation.

FIG. 13 illustrates, by way of example, a diagram of an embodiment of an architecture that is the architecture of FIG. 12 after completing a first cycle of PWMs.

FIG. 14 illustrates, by way of example, a diagram of an embodiment of an architecture that is the architecture of FIG. 13 after completing seven cycles of PWMs.

FIG. 15 illustrates, by way of example, a diagram of an embodiment of a reconfigurable butterfly architecture that supports five modes of operation.

FIG. 16 illustrates, by way of example, a block diagram of an embodiment of a method for improved reconfigurable butterfly architecture operation.

FIG. 17 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Cloud computing has become an integral part of modern society, offering various services and applications to individuals and organizations. The security of cloud computing is threatened by the advent of quantum computers, which can potentially break the existing public-key cryptosystems, such as Rivest-Shamir-Adleman (RSA) and Elliptic Curve Cryptography (ECC) based on Shor's algorithm. Shor's algorithm is a quantum computer algorithm for finding the prime factors of an integer. Current public-key cryptography is not presently threatened by modern quantum computers. However, cloud resource managers should anticipate the challenge quantum computers pose to modern cryptography and initiate a transition to a postquantum era in a timely manner. In fact, the U.S. government issued a National Security Memorandum in May 2022 that mandated federal agencies to migrate to post-quantum cryptosystems (PQC) by 2035 to mitigate risks to vulnerable cryptographic systems.

A long-term security of cloud computing against quantum attacks can benefit from developing lattice-based cryptosystems, which are among the most promising PQC algorithms that are believed to be hard for both classical and quantum computers. NTT and INTT can be used to achieve more efficient polynomial multiplication in lattice-based cryptosystems. NTT and INTT help reduce algorithm complexity from O(n²) to O(n log n). The complexity of the NTT and INTT computation can benefit from improvement in terms of efficiency so as to help improve operation of the lattice-based cryptosystems.

NTT and INTT operations can be accomplished iteratively. NTT and INTT can be performed by applying a sequence of “butterfly operations” on the input polynomial coefficients. Butterfly operations are arithmetic operations that combine two coefficients of polynomials to obtain two outputs. The NTT and INTT operations can be computed in a logarithmic number of steps using repeated butterfly operations. Traditionally, the utilization of identical butterfly configurations for both NTT and INTT necessitates the implementation of a bit-reverse function. A reconfigurable butterfly architecture provides a new approach for implementing a resource-efficient reconfigurable butterfly core on the hardware platforms. The reconfigurable butterfly architecture can be adjusted (e.g., by changing digital input to the architecture) to different NTT/INTT configurations without needing two separate butterfly cores or paying the extra costs for bit-reversal operations. The reconfigurable butterfly architecture improves the overall effectiveness of polynomial multiplication processes.

The reconfigurable butterfly architecture uses various optimization techniques, including parallel architecture, designing reconfigurable cores, and implementing pipelined architecture, that help achieve significant speedup while maintaining security.

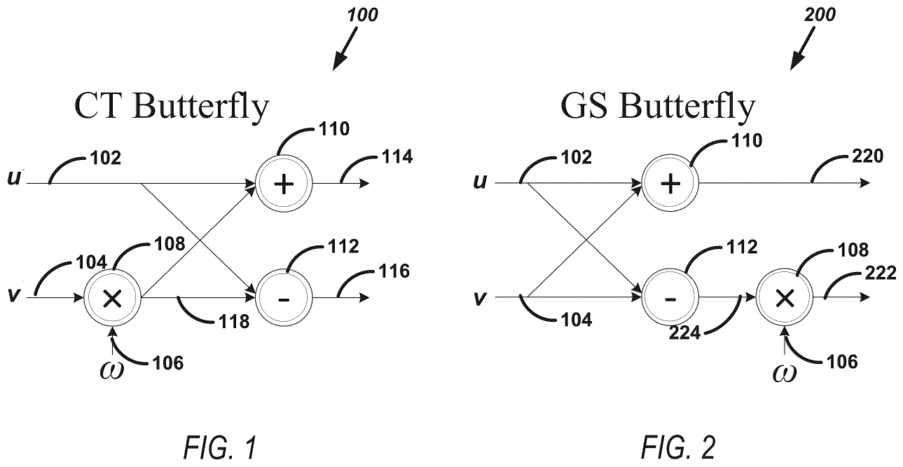

FIG. 1 illustrates, by way of example, a conceptual circuit diagram of an embodiment of a Cooley-Tukey (CT) butterfly operator circuit 100. The circuit 100 performs the CT butterfly operations. The circuit 100 takes, as input u 102 and v 104, which are coefficients of a polynomial, and ω 106, which is a weight. v 104 and ω 106 are modular multiplied ((v*ω) mod q) using a multiplier 108. A result 118 of the multiplication performed by the multiplier 108 and u 102 are added using a modular adder 110 to generate a first output coefficient 114. The result 118 and u 102 are subtracted using a modular subtractor 112 to generate a second output coefficient 116. The first and second output coefficients 114 and 116 can then be used as inputs, U and V, respectively, in a next iteration of circuit 100 operation.

Pseudocode for an iterative NTT operation using the CT butterfly operator circuit 100 is provided:

| In-Place NTT Algorithm using CT Butterfly Operator Circuit | |
|---|---|
| Require: a(x) ∈ R_{q}, ωₙ ∈ [symbol] _{q}, n = 2^{l} | |
| Ensure: â(x) = NTT(a) ∈ R_{q} | |
| 1: | â ← bit − reverse(a) |
| 2: | for i from 1 to l do |
| 3: | m = 2^{l-i} |
| 4: | for j from 0 to 2ⁱ⁻¹ − 1 do |
| 5: | $W ← {ω}_{n}^{1 + j}$ |
| 6: | for k from 0 to m − 1 do |
| 7: | U ← â[2jm + k] |
| 8: | V ← â[2jm + k + m] mod q |
| 9: | T ← V · W |
| 10: | â[2jm + k] = U + T mod q |
| 11: | â[2jm + k + m] = U − T mod q |
| 12: | end for |
| 13: | end for |
| 14: | end for |
| 15: | return â(x) ∈ R_{q} |

where a is a polynomial and ω is a twiddle factor, and n is a number of coefficients in the polynomial.

FIG. 2 illustrates, by way of example, a conceptual circuit diagram of an embodiment of a Gentleman-Sande (GS) butterfly operator circuit 200. The circuit 200 performs the mathematical operations the GS butterfly operation. The circuit 200 takes, as input u 102, v 104, and ω 106. u and v are added mod q, by modular adder 110, resulting in a first output coefficient 220. u 102 and v 104 are subtracted mod q, by modular subtractor 112, resulting in result 224. The result 224 is then multiplied by a weight, ω 106, using a modular multiplier 108. A result of the multiplication performed by the multiplier 108 is a second output coefficient 222. The first and second output coefficients 220 and 222 can then be used as inputs in a next iteration of circuit 200 operation.

What follows is a description of NTT/INTT. Let q be a prime number and [symbol] be the ring of integers modulo q. Define the ring of polynomials for some integer N as R_{q}= [symbol] _{q}= [symbol] _{q}[X]/(X^{N}+1), where the polynomials have n coefficients, each modulo q. Regular font lowercase letters (α) represent single polynomials, bold lowercase letters (α) represent polynomial vectors, and bold uppercase letters (A) to represent a matrix of polynomials. Representations in the NTT domain are represented by (\hat{α}), (\hat{α}) and (Â), respectively. Let a and b be polynomial vectors in R_{q}. Let α·b∈R_{q} denote coefficient-wise multiplication of polynomials. The ° product of a matrix and a vector is the natural extension of coefficient-wise multiplication of the polynomial vectors.

A naive method of polynomial multiplication has O(n²) complexity. This complexity can be reduced by using NTT. To multiply two polynomials efficiently in lattice-based cryptography, the polynomial rings of the form R_{q}= [symbol] _{q}[X]/(X^{N}+1) can be used, where (X^{N}+1) enables fast polynomial division. The NTT transform maps polynomials to the NTT domain at the cost of O(n·log n) where multiplying their coefficients results in a polynomial that corresponds to the product of the original polynomials modulo q and (X^{N}+1). Coefficient-wise multiplication has a complexity of O(n). A total time complexity is thus O(n·log n).

The NTT is a generalization of a fast Fourier transform (FFT) defined in a finite field. Suppose f is a polynomial of degree n with coefficients in [symbol] _{q}, as:

$$f = {\sum }_{i = 0}^{n - 1} {f}_{i} {X}^{i}$$

FFT uses the twiddle factor ωₙ n-th root of unity of form e^{2πj/n}, while NTT has ωₙ∈_{q} such that won be a primitive n-th root of unity modulo q, i.e.

$${ω}_{n}^{n} = 1 mod q .$$

The NTT transforms f, i.e., \hat{f}=NTT(f), is computed as follows for each i € {0,1, . . . , n−1}:

$$\hat{{f}_{i}} = {\sum }_{j = 0}^{n - 1} {f}_{j} {ω}_{n}^{ij}$$

The INTT recovers f from f as:

$${f}_{i} = {\sum }_{j = 0}^{n - 1} {\hat{f}}_{j} {ω}_{n}^{- ij}$$

Hence, the multiplication between two polynomials f and g using NTT can be performed as:

$$f \cdot g = INTT ( NTT ( f ) ∘ NTT ( g ) )$$

NTT algorithm is shown in pseudocode elsewhere herein.

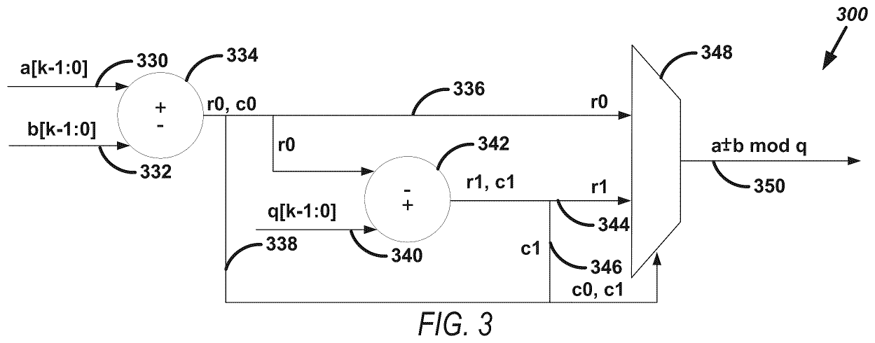

The modular addition and modular subtraction of the CT and GS butterfly operator circuits of FIGS. 1 and 2 can be implemented using two, non-modular adders and subtractors. Such a configuration is illustrated in FIG. 3.

FIG. 3 illustrates, by way of example, a diagram of an embodiment of a circuit 300 for performing modular addition and subtraction. The circuit 300 as illustrated includes non-modular adder/subtractor 334, non-modular subtractor/adder 342, and a multiplexer 348. The circuit 300 generates an output 350 that is a modular addition/subtraction of variables a 330 and b 332 modular a prime number, q.

The adder/subtractor 334 adds a 330 and b 332 when in adder mode and subtracts a 330 and b 332 when in subtractor mode. The adder/subtractor 334 is in adder mode when performing modular addition (e.g., for modular adder 110 see FIGS. 1 and 2) and in subtractor mode when performing modular subtraction (e.g., for modular subtractor 112 see FIGS. 1 and 2). The adder/subtractor 334 generates a sum 336 and a carry 338.

The subtractor/adder 342 subtracts the sum, r0, 336 and q 340 when in subtractor mode and adds the sum 336 and q 340 when in subtractor mode. The subtractor/adder 342 is in subtractor mode when performing modular addition (e.g., for modular adder 110 see FIGS. 1 and 2) and in adder mode when performing modular subtraction (e.g., for modular subtractor 112 see FIGS. 1 and 2). The subtractor/adder 342 generates a sum 344 and a carry 346.

The multiplexer 348 selects which of the sums 336, 344 is the correct output 350 based on the carry 338 and carry 346. In addition mode, r1 344 is chosen when c0 XOR c1 is 1, otherwise r0 336 is provided. In subtraction mode, if c0 338 is set (equal to “1”) r0 336 336 is provided, otherwise r1 344 is provided.

The circuit 300 of FIG. 3 performs modular addition and/or subtraction using non-modular components. Modular multiplication, the multiplier 108 of FIGS. 1 and 2, can be implemented using different techniques. The commonly used Barrett reduction and Montgomery reduction techniques require more than one multiplier and are suitable for a non-specific modulus. Further, Montgomery reduction needs two more steps to convert all inputs from normal domain to Montgomery domain and then convert back the results into normal domain. These operations converting between domains increases the latency of NTT operations and causes delay in performance. Hence, Barrett reduction and Montgomery reduction are expensive in terms of time and hardware resources.

A reconfigurable butterfly architecture supports both CT and GS operations. The CT and GS operations can be used for NTT and INTT, respectively. The reconfigurable butterfly architecture employs resource-sharing techniques and avoid the bit-reverse cost in polynomial multiplication.

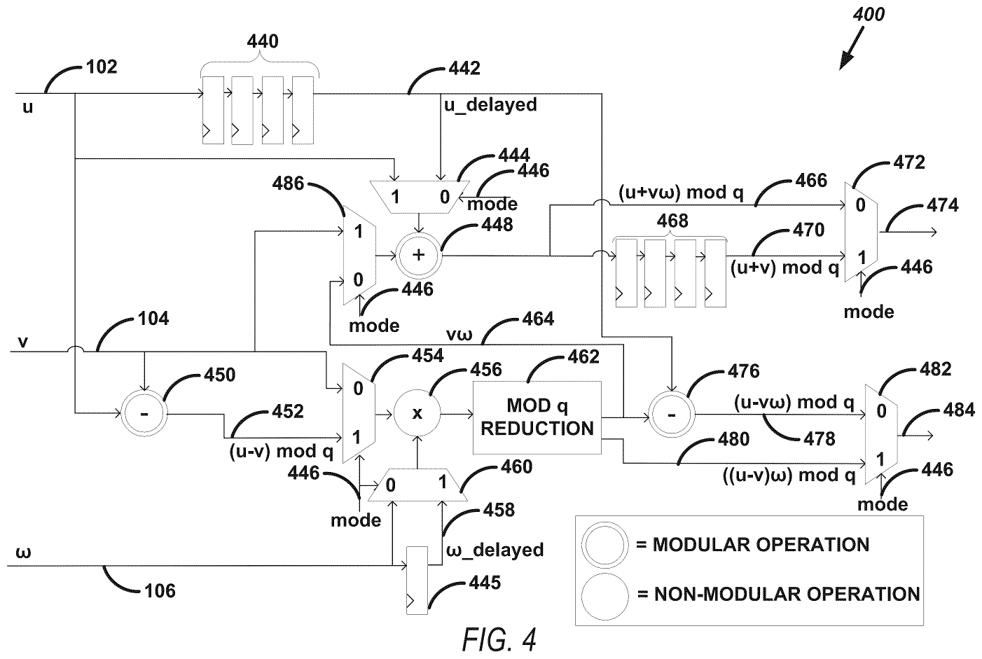

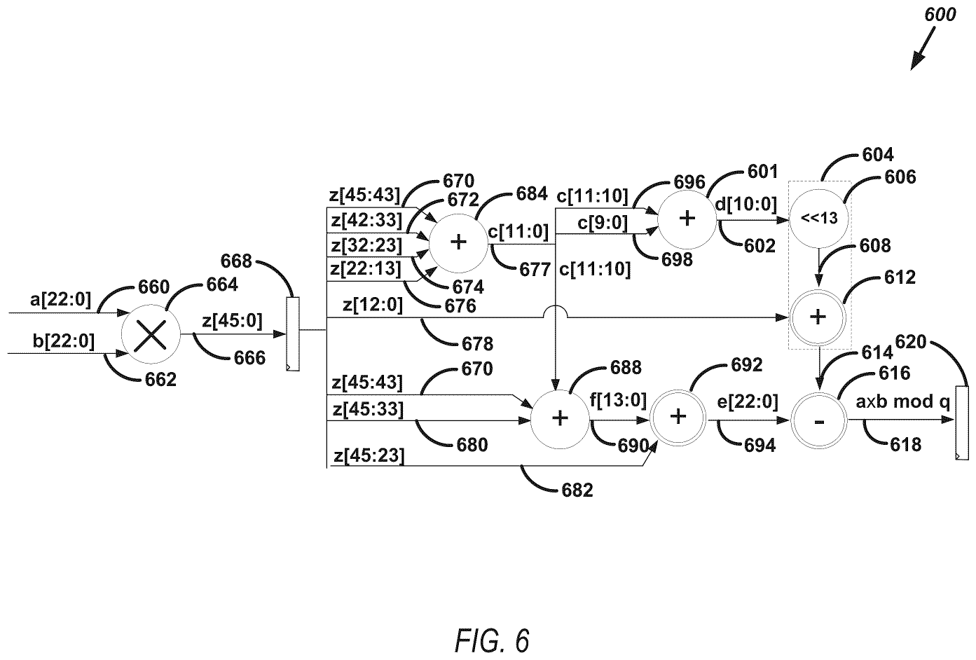

The reconfigurable butterfly architecture has only one modular multiplier. The reconfigurable butterfly architecture also has only one reduction unit and uses a modular adder/subtractor. For a comparison, using Montgomery reduction needs more resources because it involves converting from the Montgomery domain and takes more time. Further, the modular reduction (see FIG. 4 and FIG. 6, for example) is constant-time and finishes in four cycles.

To be consistent with standard implementation, the input polynomial coefficients are provided in normal order and are changed to the NTT domain in bit-reverse order using CT configuration, while twiddle factors are taken in bit-reverse order. The point-wise multiplication is done in bit-reverse order and converted back using GS configuration in normal order. However, the needed twiddle factors are taken in the bit-reversed order.

The doubled circle addition and subtraction operation in butterfly architecture shows the modular operation that performs a+b mod q and a-b mod q, respectively. The architecture of modular addition and subtraction is shown in FIG. 3.

FIG. 4 illustrates, by way of example, a diagram of an embodiment of a reconfigurable butterfly architecture 400. The architecture 400 is a circuit that allows a user to configure the architecture 400 as a GS butterfly operator circuit or a CT operator circuit. The architecture 400 when mode 446 is “1” is in GS mode and provides outputs 474, 484:

$$\begin{matrix}U = ( u + v ) mod q \\ V = ( ( ( u - v ) mod q ) ω ) mod q\end{matrix}$$

The architecture 400 when mode 446 is “0” is in CT mode and provides outputs 474, 484:

$$\begin{matrix}U = ( u + ( v ω mod q ) ) mod q \\ V = ( u - ( v ω mod q ) ) mod q\end{matrix}$$

The architecture 400 includes some flip flop delay banks 440, 468, 445 that delay the inputs u 102, v 104, ω 106, respectively, to meet timing constraints of other circuitry in the architecture 400.

The architecture 400 includes multiplexers 486, 444, 454, 460, 472, 482. The multiplexers 486, 444, 454, 460, 472, 482 are all driven by the same control signal, namely mode 446. The multiplexers 486, 444, 454, 460, 472, 482 route different inputs to their outputs based on a state of mode 446.

The architecture 400 also includes two modular subtractors 450, 476, and a modular adder 448. The modular adder 448 and the modular subtractors 450, 476 can be implemented using the circuit of FIG. 3. The architecture 400 also includes a multiplier 456 and a mod q reduction operator 462. The mod q reduction operator 462 can be implemented using the circuit 600 of FIG. 6.

The first flip flop bank 440 receives u 102. The first flip flop bank 440 provides u_delayed 442 as output. For each flip flop in the bank 440, u 102 is delayed by a single clock cycle. Thus, in the example of FIG. 4, u_delayed 442 is the u 102 that was input four clock cycles earlier.

u 102 and u_delayed 442 are provided as input to the multiplexer 444. The multiplexer 444 provides u 102 as output when in CT mode. The multiplexer 444 provides u_delayed 442 as output when in GS mode.

v 104 and vω mod q 464 are provided as input to the multiplexer 486. The multiplexer 486 provides v as output when in CT mode (when mode=0). The multiplexer 486 provides vω mod q 464 as output when in GS mode (when mode=1).

The modular adder 448, when the multiplexers 444 and 486 are in GS mode, produces (u+v) mod q 470 as output. (u+v) mod q 470 is then provided to the bank of flip-flops 468. The bank of flip flops 468 delays (u+v) mod q 470 a number of clock cycles equal to the number of flip flops in the bank of flip flops 468. The modular adder 448, when the multiplexers 444 and 486 are in CT mode, produces (u+vω) mod q466.

The multiplexer 472 receives (u+v) mod q 470 and (u+vω) mod q 466 as input. The multiplexer 472 provides (u+v) mod q 470 as output 474 when in GS mode. The multiplexer 472 provides (u+vω) mod q 466 as output 474 when in CT mode.

Modular subtractor 450 receives v 104 and u 102 as input and produces (u−v) mod q 452 as output. The multiplexer 454 receives v 104 and (u−v) mod q 452 as input. The multiplexer 454 provides y 104 as output when in CT mode. The multiplexer 454 provides (u−v) mod q 452 as output when in GS mode.

The multiplexer 460 receives ω 106 and ω_delayed 458 as input. ω_delayed 458 is the state of ω 106 delayed a number of clock cycles equal to the number of flip flops in flip flop bank 445. The multiplexer 460 provides ω 106 as output when in CT mode. The multiplexer 460 provides ω_delayed 458 as output when in GS mode.

The multiplier 456 (non-modular multiplier), when the multiplexers 454 and 460 are in CT mode, receives v 104 and ω 106 and produces vω mod q 464 as output. The multiplier 456, when the multiplexers 454 and 460 are in GS mode, receives (u−v) mod q 452 and ω_delayed 458 as input and produces (u−v)ω as output.

The modular subtractor 476 receives vω mod q 464 and u_delayed 442 as input and produces (u−vω) mod q 478 as output. The multiplexer 482 receives (u−vω)) mod q 478 and ((u−v)ω) mod q 480 as input. The multiplexer 482 provides ((u−v)ω) mod q 480 as output 484 when the multiplexer 482 is in GS mode. The multiplexer 482 provides (u−vω) mod q 478 as output 484 when the multiplexer 482 is in CT mode.

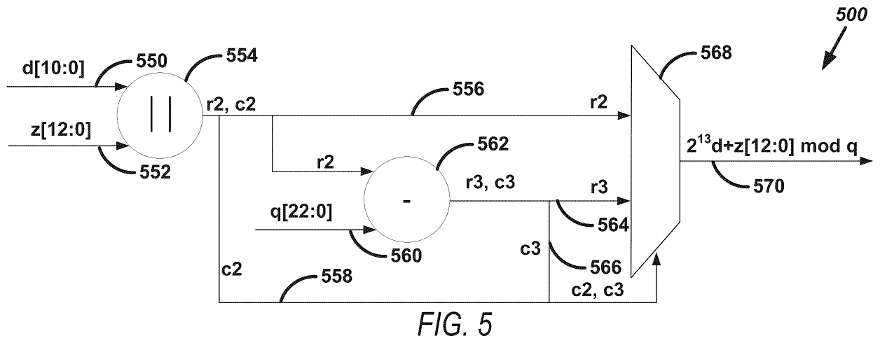

The mod q reduction operator 462 determines a remainder of an input value. The mod q reduction operator 462 provides vω mod q 464 as output when the multiplexers 454 and 460 are in CT mode. The mod q reduction operator 462 provides ((u−v)ω) mod q 480 as output when the multiplexers 454 and 460 are in GS mode. More details regarding the mod q reduction operator 462 are provided regarding FIGS. 5 and 6.

The mod q reduction operator 462 determines a remainder of an input value. The mod q reduction operator 462 provides vω mod q 464 as output when the multiplexers 454 and 460 are in CT mode. The mod q reduction operator 462 provides ((u−v)ω) mod q 480 as output when the multiplexers 454 and 460 are in GS mode. More details regarding the mod q reduction operator 462 are provided regarding FIGS. 5 and 6.

The modular subtractor 476 receives vω mod q mod q 464 and u-delayed 442 as input and produces (u−vω) mod q 478 as output. The multiplexer 482 receives (u−vω) mod q 478 and ((u−v) @)) mod q 480 as input. The multiplexer 482 provides ((u−v)ω) mod q 480 as output 484 when the multiplexer 482 is in GS mode. The multiplexer 482 provides (u−vω)) mod q 478 as output 484 when the multiplexer 482 is in CT mode.

An improved hardware accelerator includes a reduction architecture that is customized based on the prime value of q to increase the efficiency of computation. In a Dilithium architecture q=8,380,417. The value of q can be presented by a series of simple mathematical operations that reduce the complexity of operating on the prime value.

FIG. 5 illustrates, by way of example, a diagram of an embodiment of a circuit 500 for performing modular addition in a modular reduction circuit of FIG. 6. The circuit 500 as illustrated includes a shift and concatenate operator 554, non-modular subtractor 562, and a multiplexer 568. The circuit 500 generates an output 570 that is a modular addition of a specified number of bits of variables d 550 and z 552 modulo the prime number, q 560.

The shift and concatenate operator 554 shifts d 550 to the left thirteen bits (to be a bigger number with thirteen trailing zeros) to generate a left-shifted result. The shift and concatenate operator 554 concatenates the left-shifted result and the least significant thirteen bits of =552 to generate a result 556 and a carry 558. The subtractor 562 subtracts the sum 556 and q 560. The subtractor 562 generates a result 564 and a carry 566.

The multiplexer 568 selects which of the results 556, 564 is the correct output 570 based on the carry 558 and carry 566. If c2 XOR c3 is 1, then r3 564 is provided, otherwise r2 556 is provided.

Using the circuit 500, along with additional components of FIG. 6, allows one to perform a modular multiplication using a single multiplier while performing cryptography. Such a modular multiplier is illustrated in FIG. 6.

FIG. 6 illustrates, by way of example, a diagram of an embodiment of a circuit 600 for modular multiplication in cryptography operations. The modular multiplication is implemented with a 3-stage pipeline architecture. At a first stage of the pipeline, z=a·b is calculated. At a second stage of the pipeline, f+z[45:23] and 213d+z[12:0] are calculated in parallel. At a third stage of the pipeline, a modular subtraction is executed to obtain the result and the result is output.

The circuit 600 as illustrated includes a non-modular multiplier 664, a register 668, a first (non-modular) adder 684, a second (non-modular) adder 688, a third (non-modular) adder 601, a fourth (modular) adder 692, a fifth (modular) adder 604, a modular subtractor 616, and a second register 620. The circuit 600 receives two variables a 660 and b 662, determines a×b mod q as a result 618, and stores the result 618 in the register 620. All modular operations are performed modulo q.

The multiplier 664 receives the variables a 660 and b 662 and generates a product 666, z[45:0]. The product 666 is stored in the register 668. Portions of the product 666 are split off and provided to adders 684, 688, and 612. Note that adder 612 is a modular adder that is part of the modular adder 604 that is customized (can be implemented using the circuit 500 of FIG. 5).

The adder 684 receives contiguous portions of the result 666 and generates a sum 677. The contiguous portions include: (i) three most significant bits 670, z[45:43], of the product 666, (ii) ten bits 672, [42:33], of the product 666, (iii) ten bits 674, [32:23], of the product 666, and (iv) ten bits 676, [22:13], of the product 666. The sum 677 is the addition of the bits 670, 672, 674, 676 and is a maximum of twelve bits.

The adder 688 receives portions of the result 666 and a portion of the sum 677 and generates a sum 690. The portions of the result 666 include: (i) the three most significant bits 670, z[45:43] and (ii) the thirteen most significant bits 680, z[45:33]. The portion of the sum 677 is the two most significant bits 696, c[11:10]. The sum 690 is a maximum of fifteen bits, f[13:0].

The adder 692 can be implemented using the circuit 300 of FIG. 3. The adder 692 receives the twenty-three most significant bits 682, z[45:23], of the result 666 and the sum 690. The adder 692 generates a modular sum 694 of the bits 682 and the sum 690 that is a maximum of twenty-three bits, e[22:0].

The adder 601 receives contiguous portions of the sum 677 and generate a sum 602, d[10:0], that is a maximum of eleven bits. The contiguous portions of the sum 677 include: (i) the two most significant bits 696, c[11:10] and (ii) the ten least significant bits 698, c [9:0].

The modular adder 604 can be implemented using the circuit 500 of FIG. 5. The modular adder 604 shifts the sum 602 left thirteen bits using a shifter 606. A shifted sum 608 is produced by the shifter 606. Thus, if d=10101010100, the shifted sum 608 is equal to 101010101000000000000000. The modular adder 612 receives the shifted sum 608 and thirteen least significant bits 678, z[12:0], of the result 666 and generates a modulo sum 614. While the shift and concatenate operation 554 is illustrated as a single unit in FIG. 5, the modular adder 604 shows the shift operator 606 separate from the concatenate operation and the concatenate operation as part of the modular adder 612.

The modular subtractor 616 receives the sum 614 and the sum 694 and generates the result 618 that is a times b modulo q. The modular subtractor 616 can be implemented using the circuit 300 of FIG. 3. The result 618 can be stored in a register 620.

Unlike Barret and Montgomery multiplication techniques, in performing modular multiplication for cryptography using the circuit 600 no extra multiplications are used for modular reduction. The operations of the circuit 600 do not depend on the input data and do not leak any information. The reduction is fast, efficient and constant-time.

The circuit 600 is a hardware-friendly reduction architecture, which can offer more efficiency. The circuit 600 enables one to avoid using any extra multipliers (beyond a single multiplier) for modular multiplication. Keeping the number of multipliers to one in performing modular multiplication results in higher efficiency in terms of hardware resource usage and time. The circuit 600 can be optimized and mapped to field programmable gate array (FPGA) and application specific integrated circuit (ASIC) platforms, such as to develop a highly efficient PQC cryptography architecture.

Using the circuit 400 of FIG. 4, to be consistent with standard implementation, the input polynomials in normal order are changed to the NTT domain in bit-reverse order using CT configuration, while twiddle factors are taken in bit-reversed order. The point-wise multiplication is done in bit-reverse order and converted back using GS configuration in normal order. However, the twiddle factors are taken in the bit-reversed order.

Mode selection is used to choose the correct inputs to the modular adder and multiplier based on CT or GS configuration as well as choose the correct computed values to pass to outputs. Each modular multiplication operation uses 4 clocks to produce a valid output. In mode 0, to match this latency requirement, u 102 input to the modular adder 448 is delayed by 4 cycles. Similarly, u 102 input to the modular subtractor 476 is also delayed by 4 cycles. In mode 1, the result of the modular adder 448 is delayed before driving the output to match the v104 coefficient computed through the “modular multiplication branch”. The modular multiplication branch includes the multiplier 456 and the mod q reduction 462.

The improved reconfigurable butterfly architecture includes a pipelined architecture that produces U and V outputs every cycle. Inputs can be supplied every cycle on which modular operations are performed. The results of these are registered while the arithmetic units begin to work on the next available inputs. Each branch of the reconfigurable butterfly architecture takes 5 cycles to produce a valid output, irrespective of the mode, of which, 4 cycles are needed for modular multiplication and 1 cycle is needed for modular addition or subtraction. Hence the total latency of the reconfigurable butterfly architecture is five cycles end to end. After a latency of 5 cycles, the reconfigurable butterfly architecture will start producing valid outputs every cycle giving a performance improvement of 5×.

From a resource sharing and efficiency point of view, the reconfigurable butterfly architecture presents a significant improvement over a basic, unoptimized design that would typically involve two separate butterfly cores. The reconfigurable butterfly architecture manages to reduce the hardware requirements by one less multiplier, one less reduction, and one less addition. This is a substantial saving, considering that each of these components represents a considerable portion of the total hardware cost and complexity.

The proposed optimization does not come at the expense of performance or increased complexity. Instead, it is accomplished through the strategic use of only a few multiplexers. Multiplexers are relatively simple components with negligible hardware cost. Their simplicity and low hardware cost make them an ideal choice for achieving the desired optimization. In comparison to the resources saved—the multiplier being the most costly among them—the additional multiplexers add minimal overhead. This makes our proposed architecture not only more resource-efficient but also potentially more cost-effective, as it conserves valuable hardware resources without compromising on functionality.

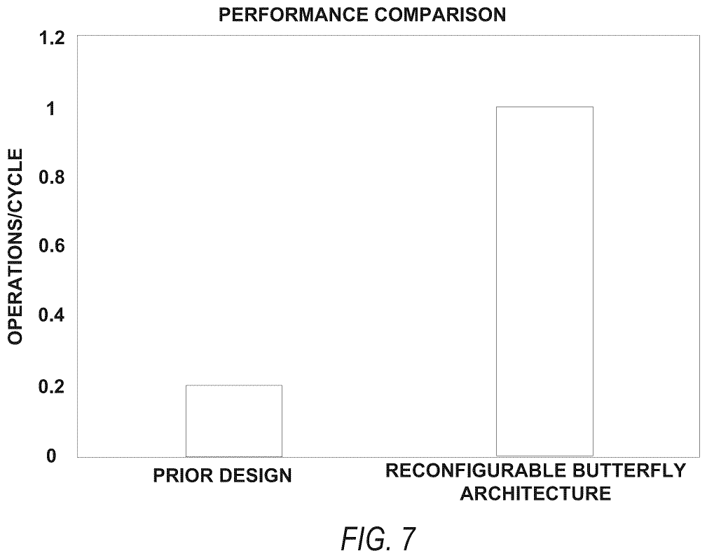

FIG. 7 illustrates, by way of example, a graph of a performance comparison (in units of operations performed/cycle). As can be seen, the reconfigurable butterfly architecture of FIG. 3 increases operations performed by about 5× over the most efficient prior designs.

A common operation in current post-quantum cryptography (PQC) schemes is polynomial multiplication. Polynomial multiplication can be accelerated using NTT and INTT. NTT is a fast Fourier transform (FFT) applied in a finite field. The polynomial multiplication using NTT is as follows:

$$f \cdot g = INTT ( N T T [ f \cdot g ) ) = I N T T ( N TT ( f ) ∘ NT T ( g ) )$$

An INTT operation is an iterative operation that applies a sequence of butterfly operations on the input polynomial coefficients. A butterfly operation is an arithmetic operation that combines two coefficients to obtain two outputs. By repeating this process for different pairs of coefficients, the NTT/INTT operation can be computed in a logarithmic number of steps. CT and GS butterfly configurations can be used to facilitate NTT/INTT computation.

Let f be a polynomial as follows:

$$f = {\sum }_{j = 0}^{n - 1} {f}_{j} {X}^{j} = {f}_{0} + {f}_{1} X + … + {f}_{n - 1} {X}^{n - 1} , f ∈$$

f can be represented as a vector of coefficients as follows:

$$f = ( {f}_{0} , {f}_{1} , … , {f}_{n - 1} ) , {f}_{i} ∈ = [ 0 , q )$$

To convert the polynomial f into NTT domain, NTT function is defined as follows:

$$NTT ( f ) : \hat{{f}_{i}} = {\sum }_{j = 0}^{n - 1} {f}_{j} {ω}_{n}^{ij} mod q$$

Where ω is the first primitive 512-th root of unity modulo q.

The INTT operation is similar to NTT with the ω⁻¹ used instead of ω. Further, after performing all butterfly operations, there is a subsequent step in which all coefficients are divided by the total number of coefficients, denoted as N.

$$I N T T ( \hat{f} ) : {f}_{i} = {n}^{- 1} {\sum }_{j = 0}^{n - 1} {\hat{f}}_{i} {ω}_{n}^{- ij} mod q$$

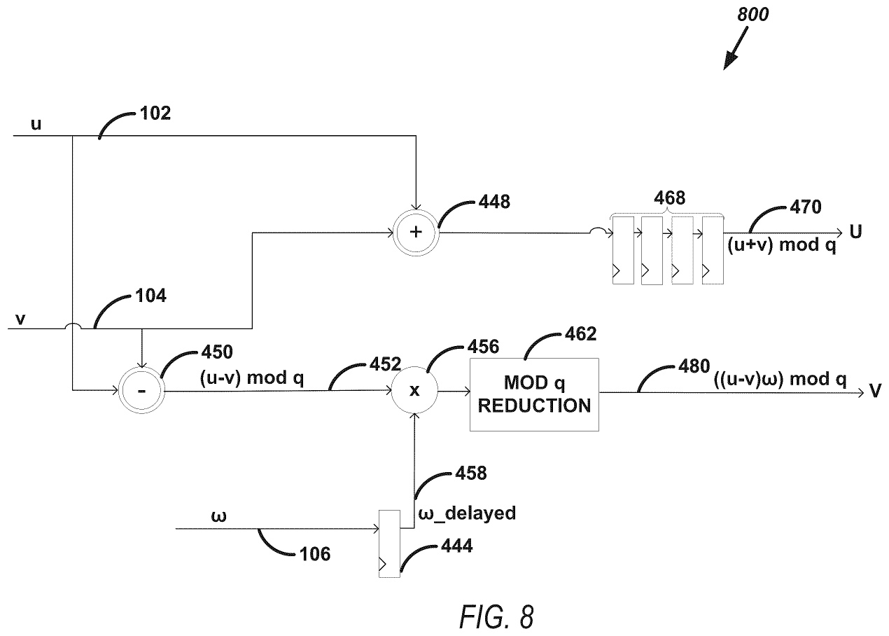

The original computing of NTT and INTT need the pre-processing and the post-processing of division by the total number of coefficients, respectively. The regular GS butterfly used in INTT algorithm is shown in FIG. 8.

FIG. 8 illustrates, by way of example, a circuit diagram of a circuit 800 that is the reconfigurable butterfly architecture of FIG. 4 when in GS mode. The circuit 800 shows the components of the architecture 400 that operate when mode is set to “1”.

After all butterfly operations are performed, N additional operations need to be performed as a post-processing step. If one ignores the cost of addition/subtraction compared to multiplication, the post-processing step overhead is around

$$\frac{N}{N log N + N} = \frac{1}{log N + 1} .$$

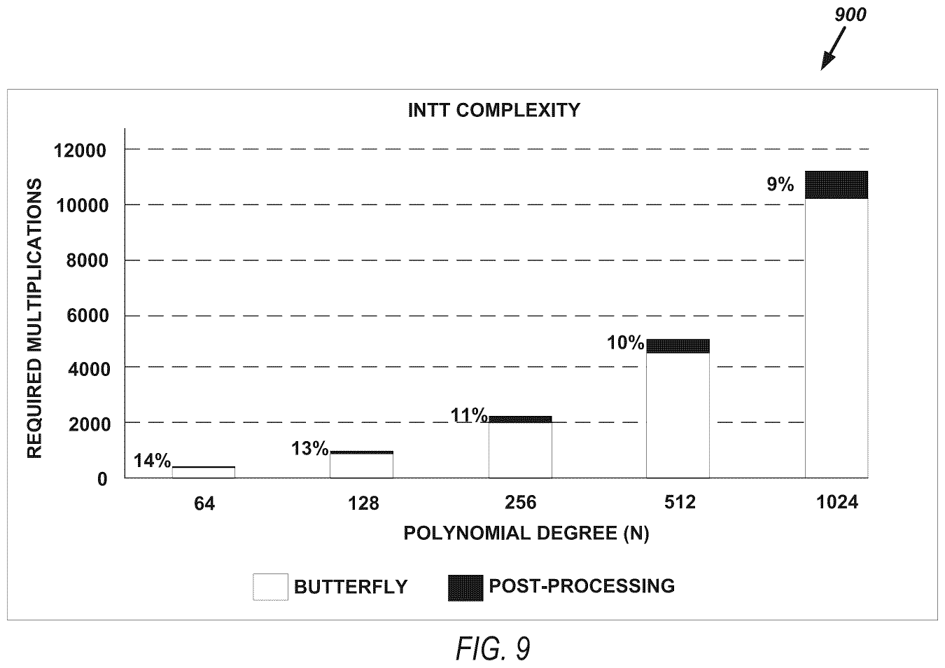

FIG. 9 shows the INTT complexity for different polynomial degrees.

FIG. 9 illustrates by way of example, a graph 900 of multiplications executed in performing INTT for butterfly operations and post-processing. The number by the post-processing portion of a bar in the graph 900 is the percentage of post-processing multiplications as a function of the total number of multiplications.

The post-processing step can be integrated into the GS butterfly architecture. The architecture does the division operations and then post-processing to obtain the final output, but the suggested approach offers a more efficient option. Instead of postponing until the completion of the computation, the proposal breaks the post-processing normalization into butterfly stages to make it faster. By distributing this division across the stages, the algorithm achieves the same output while improving efficiency. This optimization can be particularly beneficial for large-scale computations, where minimizing computational overhead is crucial.

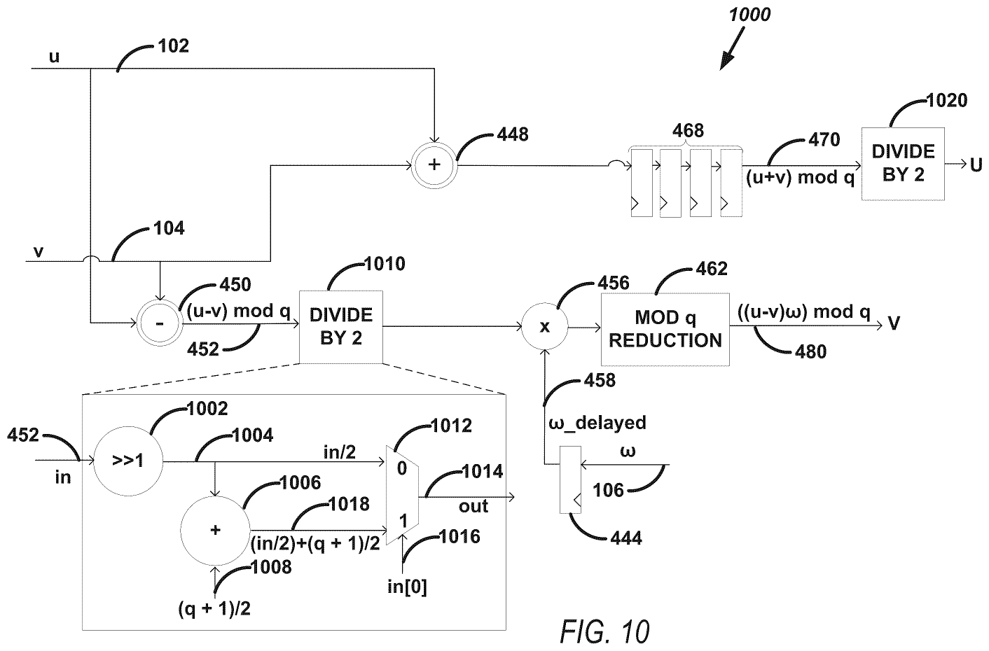

FIG. 10 illustrates, by way of example, a circuit diagram of an improved reconfigurable butterfly circuit 1000 in GS mode. The circuit 1000 is similar to the circuit 800 with the circuit 1000 including a divide by two (“2”) operator 1010 situated to receive output of the modular subtractor 450 and provide input to the multiplier 456 and another divide by two operator 1020 situated to receive output of the flip flop bank 468. The architecture 1000 includes what is typically a post-processing step within the GS butterfly architecture workflow. This integration allows the architecture 1000 to perform operations concurrently with post-processing, streamlining the path to the final output. The architecture 1000 optimizes efficiency by interleaving the post-processing normalization throughout the butterfly stages, rather than deferring it until all computations are complete. Distributing the normalization process across various stages not only maintains the integrity of the output but also enhances computational speed.

The divide by two operator 1010 can be implemented in a variety of ways. The illustrated way includes a shift operator 1002, an adder 1008, and a multiplexer 1012. The shift operator 1002 shifts the input 452 to the right one bit. If the input is even, this is all that is required to divide by 2. A result 1004 of the shift is provided to the multiplexer 1012.

If the input 452 is odd, the multiplexer 1012 provides a different output 1014. An adder 1006 adds the result 1004 to (q+1)/2 1008 to generate a sum 1018. The multiplexer 1012 then provides the sum 1018 when the input 452 is odd. The multiplexer 1012 is controlled by a control signal 1016 that is the least significant bit of the input 452. The control signal 1016 indicates whether the input 452 is even or odd.

In the architecture 1000, there are 4 flips flops connected to each other in series in the flip flop bank 468. This works because modular multiplication latency takes four cycles. The flip flop bank 468 thus balances the paths to U and V. The final result from addition and the intermediate result from subtraction is processed by the divide by two operator 1010. However, the output 1014 is an input operand for multiplication and should be less than q to have a modular operation.

There are two cases for the input value of divide by two operator 1010: If the input value is even, shifting to the right by one bit handles this operation. This operation ensures that the result is halved, which is part of the normalization process in the architecture 1000. Since the input value is less than q, it is guaranteed that the output is also less than q. However, in the case of odd input, the shifted value can be added to (q+1)/2 before providing it as the output 1014. Since input is an odd value, the maximum value of input in this case is q−2. Then, the maximum value of the output would be (4−2)/2+(q+1)/2=(2q−1)/2 which is less than q. Hence, the input operand to the multiplier is guaranteed to be less than q without the need for modular addition in the divide by two operator 1010.

The architecture 1000 incorporates post-processing INTT into the butterfly structure, which can improve performance. This improvement is particularly beneficial for large-scale calculations where lowering computational cost is very important. The architecture 1000 allows one to create a quick hardware structure of INTT that can be adjusted and fitted to FPGA and ASIC platforms to develop a high-performance PQC structure.

Polynomial multiplication in NTT domain can be performed using point-wise multiplication (PWM). Considering an optimized NTT architecture with 4 butterfly units, there are 4 modular multiplications that can be reused in a point-wise polynomial coefficient multiplication operation. This approach enhances the design from an optimization perspective through a resource sharing technique.

An improved PWM architecture solves issues of high memory usage created by large public-key sizes in PQC schemes on hardware systems. The architecture 1000 addresses problems concerning memory bandwidth, storage demands, and performance constraints.

To optimize memory usage, the summed results of PWM are allocated to the prior addresses in the memory. This approach allows for storing a singular polynomial achieving up to 7 times less memory than prior techniques. Additionally, public keys can be generated on-the-fly, minimizing the need to hold a 42 KB matrix A. In a bubble rejection sampler situation, the architecture 1000 can include a feature that pauses reading from memory until the sampler provides a valid input.

There are two use-cases for PWM:

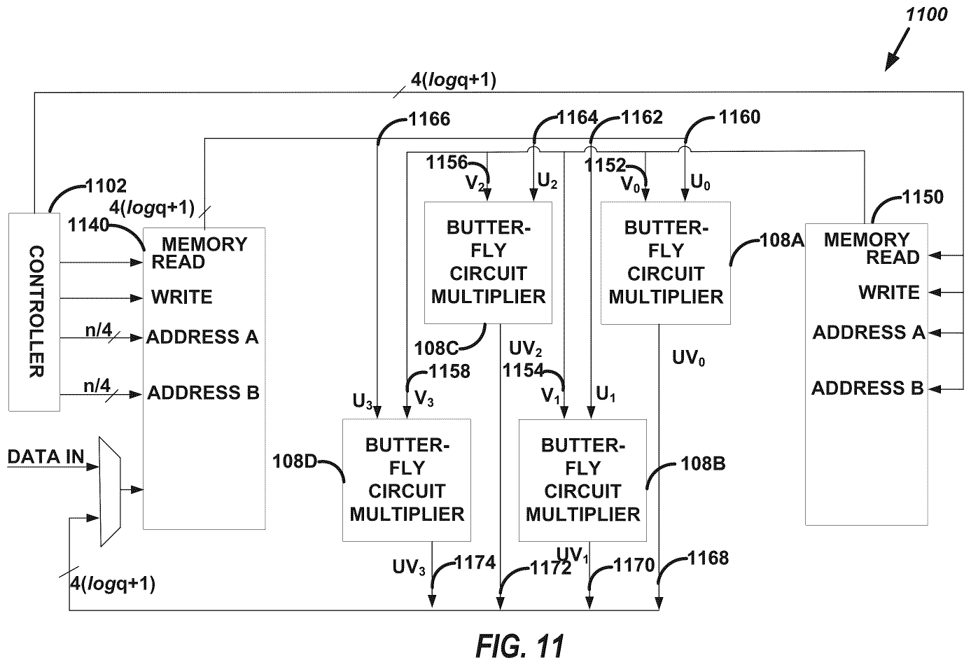

1) There are 2 memories containing polynomial f and g, with 4 coefficients per each memory address. The parallel butterfly cores enable one to perform 4 point-wise multiplication operations with 4 parallel coefficients as in FIG. 11.

2) There is a series of PWM that is to be accumulated. In this case, Rejection sampling is used to generate public-key A and can be directly connected to PWM operation. The required operation with accumulation is as follows:

$$[ \begin{matrix}{A}_{0 , 0} & … & {A}_{0 , l - 1} \\ ⋮ & ⋱ & ⋮ \\ {A}_{k - 1 , 0} & … & {A}_{k - 1 , l - 1}\end{matrix} ] ∘ [ \begin{matrix}{s}_{1 , 0} \\ ⋮ \\ {s}_{1 , l - 1}\end{matrix} ] = [ \begin{matrix}{A}_{0 , 0} ° {s}_{1 , 0} + … + {A}_{0 , l - 1} ° {s}_{1 , l - 1} \\ ⋮ \\ {A}_{k - 1 , 0} ° {s}_{1 , 0} + … + {A}_{k - 1 , l - 1} ° {s}_{1 , l - 1}\end{matrix} ]$$

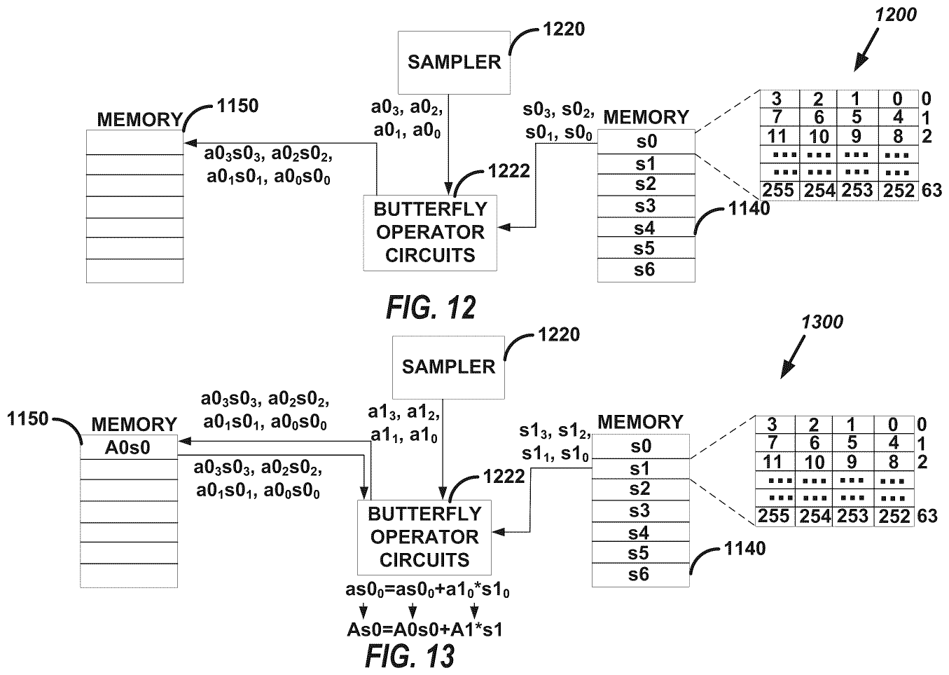

In this case, matrix A is generated by a rejection sampler and directly connected to PWM, while vectors of s are already stored in memory. The architecture of FIG. 12 shows how to compute the first element as A00*s0.

FIG. 11 illustrates, by way of example, a diagram of a circuit 1100 for polynomial multiplication in the NTT domain that reuses resources of the circuits 100 and 200. The circuit 1100 as illustrated includes two memories, memory 1140 and a memory 1150. The memory 1140 includes the coefficients of a first polynomial in NTT domain. The memory 1150 includes the coefficients of a second polynomial in NTT domain. The controller 1102 controls which addresses are read from each of the memories 1140, 1150 at a given iteration. Each address of the memories 1140, 1150 includes four coefficients in the NTT domain. In the example illustrated, coefficients 1152, 1154, 1156, 1158 are provided from the memory 1150 in a single memory read and the coefficients 1160, 1162, 1164, 1166 are provided from the memory 1140 in a single memory read.

One coefficient from each memory 1140, 1150 is provided to each of the multipliers 108A, 108B, 108C, 108D. The multipliers 108A-D are specific instances of the multiplier 108 shown in FIGS. 1 and 2. Each of the multipliers 108A, 108B, 108C, 108D operate in parallel to generate respective products 1168, 1170, 1172, 1174. The products 1168, 1170, 1172, 1174 can then be converted out of NTT domain using INTT.

FIG. 12 illustrates, by way of example, a diagram of an embodiment of a circuit architecture 1200 that includes PWM for key generation. In the architecture 1200 a rejection sampler 1220 samples A and provides samples to the butterfly operator circuits 1222. The butterfly operator circuits 1222 receive polynomial coefficients from a memory 1140. The butterfly operator circuits 1222 multiply the coefficients from the memory 1140 by corresponding samples from the sampler 1220. The butterfly operator circuits 1222 are controlled, by the controller 1102 (see FIG. 11) to accumulate totals in the memory 1150.

The controller 1102 reads one address of the memory 1140 per cycle and in a pipeline architecture. The point-wise multiplication by the butterfly operator circuits 1222 between 4 coefficients of A0₀ and s0 is performed in parallel. Then, the result will be stored the memory 1150. This routine continues until all 64 addresses (totally 256 coefficients of A0₀ and s0) have been read and operated on.

In the case of a bubble from the rejection sampler 1220, there is a mechanism in the butterfly operator circuits 1222 that holds reads processed from the memory 1140 until a valid input from the rejection sampler 1220 can be delivered. After finishing the first polynomial multiplication, the result from the second polynomial multiplication is accumulated with the previous result.

FIG. 13 illustrates, by way of example, a diagram of an embodiment of an architecture 1300 that is the architecture 1200 after completing a first cycle of PWMs. In the example of FIG. 13, the multiplication between A0₁ and s1 is performed while the results of A0₀s0 is read from the memory 1150 and accumulated into the current operation by the butterfly operator circuits 1222. In some instances, there are two reading ports from the memory 1150 and 1140, while there is only one writing port into the memory 1150.

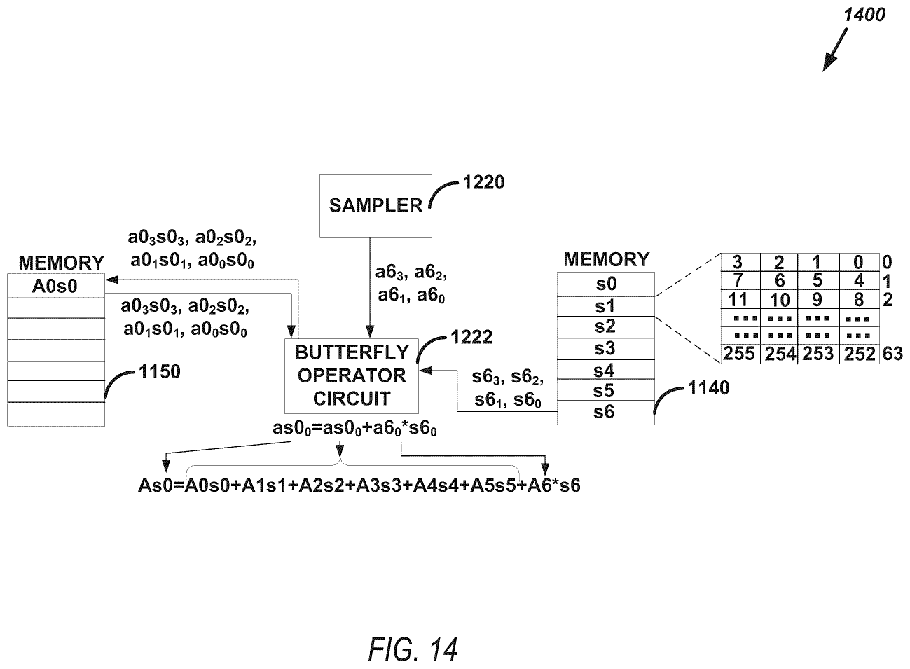

To optimize memory usage, the summed results can be allocated to a prior address in the memory 1150. This approach allows for storing a singular polynomial as opposed to seven. This process will continue until the first polynomial of A*s is generated as in FIG. 14. FIG. 14 illustrates, by way of example, a diagram of an embodiment of an architecture 1400 that is the architecture 1300 after completing seven cycles of PWMs.

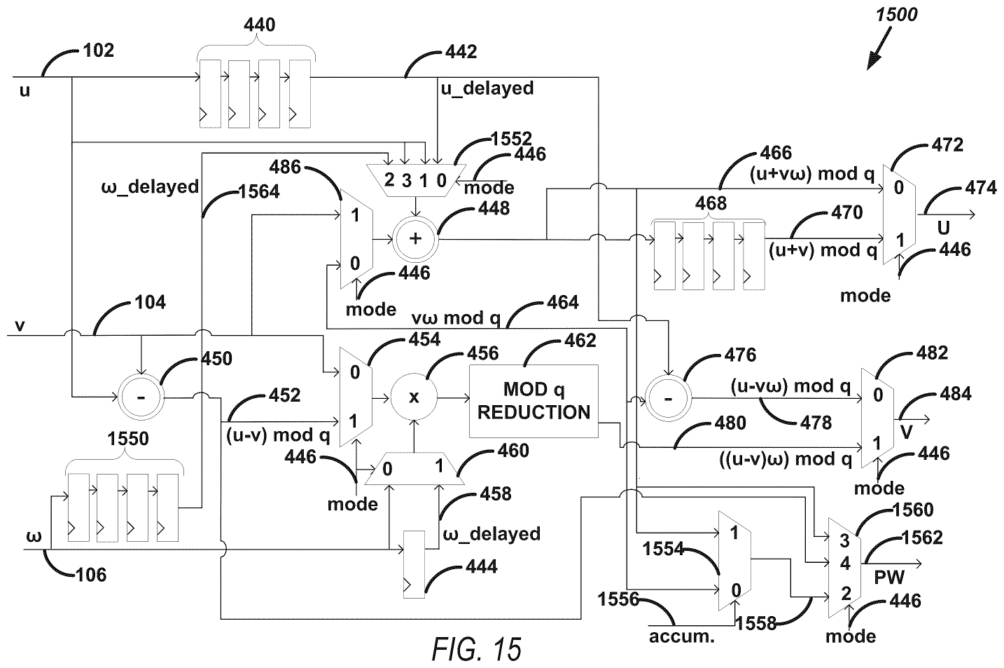

FIG. 15 illustrates, by way of example, a diagram of an embodiment of a reconfigurable butterfly architecture 1500 that supports five modes of operation. The five modes of operation include CT mode (NTT) (mode=0), GS mode (INTT) (mode=1), PWM (mode=2), point-wise addition (PWA) (mode=3), and point-wise subtraction (PWS) (mode=4).

The architecture 1500 is similar to the architecture 400 of FIG. 4 with the architecture 1500 including some additional circuitry and a modification to the multiplexer 444. In the architecture 1500, the multiplexer 444 is replaced with a multiplexer 1552 that includes four inputs and one output. The additional circuitry in the architecture 1500 includes a flip flop bank 1550 and two additional multiplexers 1554 and 1560.

The multiplexer 1552 receives u_delayed 442, u 102, and ω_delayed 1564 as input. ω_delayed 1564 is ω 106 in a state that is delayed a number of clock cycles equal to the number of flip flops in flip flop bank 1550. The multiplexer 1552, when mode 446 is set to NTT provides u_delayed 442 as output. The multiplexer 1552, when mode 446 is set to either INTT or PWA provides u 102 as output. The multiplexer 1552, when mode 446 is set to PWM provides ω_delayed 1564 as output.

The multiplexer 1554 receives (u+vω) mod q 466 and vω mod q 464 as input. The multiplexer 1554 is controlled by an accumulate 1556 control signal. When accumulate 1556 is set to one, the multiplexer 1554 provides (u+vω) mod q 466 as output 1558. When accumulate 1556 is set to zero, the multiplexer 1554 provides vω mod q 464 as output 1558.

The multiplexer 1560 receives (u+vω) mod q 466, the output 1558, and (u−v) mod q 452 as input. The multiplexer 1560, when mode is set to PWM provides the output 1558 as output 1562. The multiplexer 1560, when mode is set to PWA provides a+v 466 as output 1562. The multiplexer 1560, when mode is set to PWS provides (u−v) mod q 452 as output 1562.

The architecture 1500 helps resolve memory demand problem for PWM architecture with 4 butterfly circuit operators. The architecture 1500 lowers the amount of memory requirement and handles the bubble in pipeline architecture due to rejection sampling process. This approach enables us to design a compact hardware architecture of PWM that can be optimized and mapped to FPGA and ASIC platforms to develop a high-performance PQC architecture.

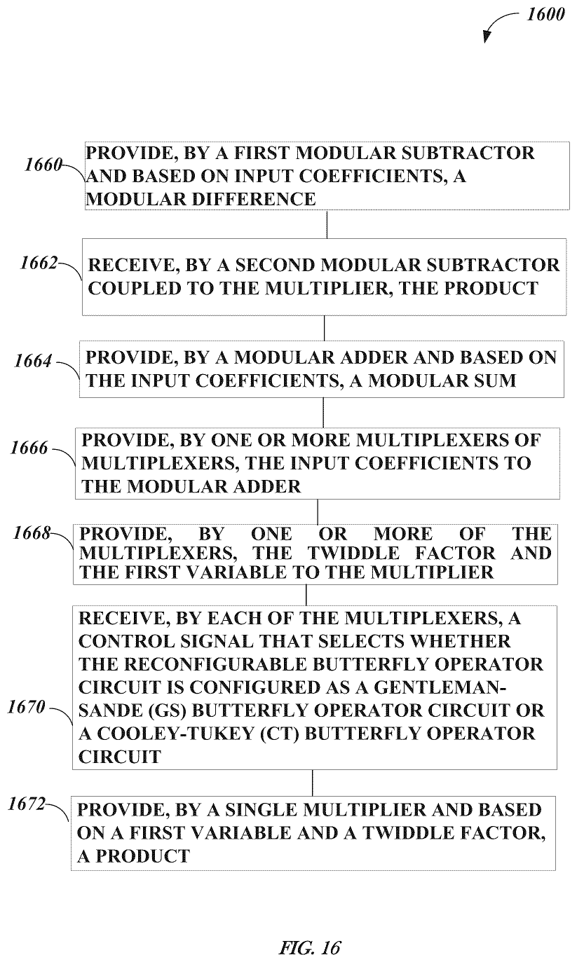

FIG. 16 illustrates, by way of example, a block diagram of an embodiment of a method 1600 for improved reconfigurable butterfly architecture operation. The method 1600 as illustrated includes providing, by a first modular subtractor and based on input coefficients, a modular difference, at operation 1660; providing, by a single multiplier and based on a first variable and a twiddle factor, a product, at operation 1662; receiving, by a second modular subtractor coupled to the multiplier, the product, at operation 1664; providing, by a modular adder and based on the input coefficients, a modular sum, at operation 1666; providing, by one or more multiplexers of the multiplexers, the input coefficients to the modular adder, at operation 1668; providing, by one or more of the multiplexers, the twiddle factor and the first variable to the multiplier, at operation 1670; and receiving, by each of the multiplexers, a control signal that selects whether the reconfigurable butterfly operator circuit is configured as a Gentleman-Sande (GS) butterfly operator circuit or a Cooley-Tukey (CT) butterfly operator circuit, at operation 1672.

The method 1600 can further include delaying, by a first bank of flip flops connected in series with each other, an input coefficient of the input coefficients. The method 1600 can further include delaying, by a second bank of flip flops connected in series of with each other, the modular sum. The method 1600 can further include providing, by a divide by two operator coupled to receive the modular difference, a quotient that is the modular difference divided by two to a modular reduction operator. The control signal can further select whether the multiplexers are in point-wise multiplication (PWM), point-wise addition (PWA), and point-wise subtraction (PWS) mode.

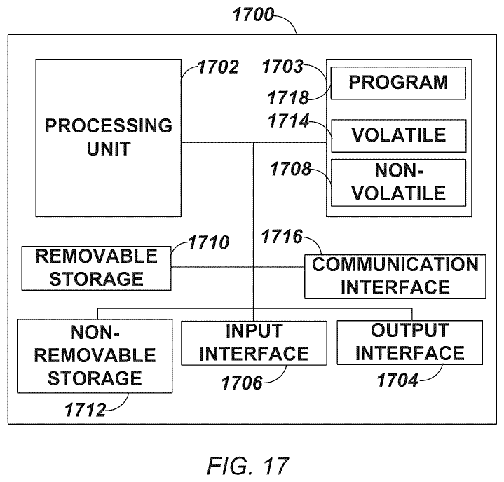

FIG. 17 illustrates, by way of example, a block diagram of an embodiment of a machine 1700 (e.g., a computer system) to implement one or more embodiments. The machine 1700 can implement a reconfigurable butterfly operator circuit. Any of the CT butterfly operator circuit 100, GS butterfly operator circuit 200, components of the circuit 300, components of the circuit 400, components of the circuit 500, components of the circuit 600, components of the circuit 700, components of the circuit 800, components of the circuit 900, components of the circuit 1000, components of the circuit 1100, components of the circuit 1200, components of the circuit 1300, components of the circuit 1400, components of the circuit 1500, method 1600, or a component or operation thereof can include one or more of the components of the machine 1700. One or more of the CT butterfly operator circuit 100, GS butterfly operator circuit 200, components of the circuit 300, components of the circuit 400, components of the circuit 500, components of the circuit 600, components of the circuit 700, components of the circuit 8 00, components of the circuit 900, components of the circuit 1000, components of the circuit 1100, components of the circuit 1200, components of the circuit 1300, components of the circuit 1400, components of the circuit 1500, or a component or operation thereof can include one or more of the components of the machine 1700, or a component or operations thereof can be implemented, at least in part, using a component of the machine 1700. One example machine 1700 (in the form of a computer), may include a processing unit 1702, memory 1703, removable storage 1710, and non-removable storage 1712. Although the example computing device is illustrated and described as machine 1700, the computing device may be in different forms in different embodiments. For example, the computing device may instead be a smartphone, a tablet, smartwatch, or other computing device including the same or similar elements as illustrated and described regarding FIG. 17. Devices such as smartphones, tablets, and smartwatches are generally collectively referred to as mobile devices. Further, although the various data storage elements are illustrated as part of the machine 1700, the storage may also or alternatively include cloud-based storage accessible via a network, such as the Internet.

Memory 1703 may include volatile memory 1714 and non-volatile memory 1708. The machine 1700 may include—or have access to a computing environment that includes—a variety of computer-readable media, such as volatile memory 1714 and non-volatile memory 1708, removable storage 1710 and non-removable storage 1712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1700 may include or have access to a computing environment that includes input 1706, output 1704, and a communication connection 1716. Output 1704 may include a display device, such as a touchscreen, that also may serve as an input device. The input 1706 may include one or more of a touchscreen, touchpad, mouse, keyboard, camera, one or more device-specific buttons, one or more sensors integrated within or coupled via wired or wireless data connections to the machine 1700, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1702 (sometimes called processing circuitry) of the machine 1700. A hard drive, CD-ROM, and RAM are some examples of articles including a non-transitory computer-readable medium such as a storage device. For example, a computer program 1718 may be used to cause processing unit 1702 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a reconfigurable butterfly operator circuit comprising a single multiplier configured to receive a first variable and a twiddle factor and produce a product, first and second modular subtractors coupled to the multiplier, the first modular subtractor coupled to receive input coefficients and provide a modular difference, and the second modular subtractor coupled to receive the product, a modular adder coupled to receive the input coefficients and provide a modular sum, and multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the reconfigurable butterfly operator circuit is configured as a Gentleman-Sande (GS) butterfly operator circuit or a Cooley-Tukey (CT) butterfly operator circuit.

In Example 2, Example 1 further includes a first bank of flip flops connected in series with each other, the first bank of flip flops coupled to delay an input coefficient of the input coefficients.

In Example 3, Example 2 further includes a second bank of flip flops connected in series of with each other, the second bank of flip flops coupled to delay the modular sum.

In Example 4, Example 3 further includes a third flip flop, the third flip flop coupled to delay a twiddle factor.

In Example 5, Example 4 further includes a modular reduction operator configured to determine a modulus of the product and provide the modulus of the product to the modular subtractor.

In Example 6, Example 5 further includes, wherein the multiplexers include a first multiplexer coupled to receive the delayed input coefficient and the input coefficient.

In Example 7, Example 6 further includes, wherein the multiplexers include a second multiplexer coupled to receive the modular difference and a second input coefficient of the input coefficients.

In Example 8, Example 7 further includes, wherein the multiplexers include a third multiplexer coupled to receive the twiddle factor and the delayed twiddle factor.

In Example 9, Example 8 further includes, wherein the multiplexers include a fourth multiplexer coupled to receive output of the second modular subtractor and output of the modular reduction operator.

In Example 10, Example 9 further includes, wherein the multiplexers include a fifth multiplexer coupled to receive the modular sum and the modular sum delayed by a fourth bank of flip flops.

In Example 11, at least one of Examples 5-10 further includes a divide by two operator coupled to receive the modular difference, generate a quotient that is the modular difference divided by two, and provide the quotient to the modular reduction operator.

In Example 12, at least one of Examples 1-11 further includes, wherein the control signal further selects whether the multiplexers are in point-wise multiplication (PWM), point-wise addition (PWA), and point-wise subtraction (PWS) mode.

Example 13 includes a method for operating a reconfigurable butterfly operator circuit, the method comprising providing, by a first modular subtractor and based on input coefficients, a modular difference, providing, by a single multiplier and based on a first variable and a twiddle factor, a product, receiving, by a second modular subtractor coupled to the multiplier, the product, providing, by a modular adder and based on the input coefficients, a modular sum, providing, by one or more multiplexers of the multiplexers, the input coefficients to the modular adder, providing, by one or more of the multiplexers, the twiddle factor and the first variable to the multiplier, and receiving, by each of the multiplexers, a control signal that selects whether the reconfigurable butterfly operator circuit is configured as a Gentleman-Sande (GS) butterfly operator circuit or a Cooley-Tukey (CT) butterfly operator circuit.

In Example 14, Example 13 further includes delaying, by a first bank of flip flops connected in series with each other, an input coefficient of the input coefficients.

In Example 15, Example 14 further includes delaying, by a second bank of flip flops connected in series of with each other, the modular sum.

In Example 16, at least one of Examples 13-15 further includes providing, by a divide by two operator coupled to receive the modular difference, a quotient that is the modular difference divided by two to a modular reduction operator.

In Example 17, at least one of Examples 13-16 further includes, wherein the control signal further selects whether the multiplexers are in point-wise multiplication (PWM), point-wise addition (PWA), and point-wise subtraction (PWS) mode.

Example 18 includes reconfigurable butterfly operator circuit including a first modular subtractor coupled to receive input coefficients and provide a first modular difference, a single multiplier configured to receive a first variable and a twiddle factor and produce a product, a first bank of flip flops connected in series with each other, the first bank of flip flops coupled to delay a first input coefficient of the input coefficients, a second modular subtractor coupled to receive the product and the first input coefficient and provide a second modular difference, a modular adder coupled to receive the input coefficients and provide a modular sum, a second bank of flip flops connected in series of with each other, the second bank of flip flops coupled to delay the modular sum, and multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the reconfigurable butterfly operator circuit is configured as a Gentleman-Sande (GS) butterfly operator circuit or a Cooley-Tukey (CT) butterfly operator circuit.

In Example 19, Example 18 further includes a divide by two operator coupled to receive the modular difference, generate a quotient that is the modular difference divided by two, and provide the quotient to a modular reduction operator.

In Example 20, at least one of Examples 18-19 further includes, wherein the control signal further selects whether the multiplexers are in point-wise multiplication (PWM), point-wise addition (PWA), and point-wise subtraction (PWS) mode.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A reconfigurable butterfly operator circuit comprising:
a single multiplier configured to receive a first variable and a twiddle factor and produce a product;
first and second modular subtractors coupled to the multiplier, the first modular subtractor coupled to receive input coefficients and provide a modular difference, and the second modular subtractor coupled to receive the product;
a modular adder coupled to receive the input coefficients and provide a modular sum; and
multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the reconfigurable butterfly operator circuit is configured as a Gentleman-Sande (GS) butterfly operator circuit or a Cooley-Tukey (CT) butterfly operator circuit.

2. The circuit of claim 1, further comprising a first bank of flip flops connected in series with each other, the first bank of flip flops coupled to delay an input coefficient of the input coefficients.

3. The circuit of claim 2, further comprising a second bank of flip flops connected in series of with each other, the second bank of flip flops coupled to delay the modular sum.

4. The circuit of claim 3, further comprising a third flip flop, the third flip flop coupled to delay a twiddle factor.

5. The circuit of claim 4, further comprising a modular reduction operator configured to determine a modulus of the product and provide the modulus of the product to the modular subtractor.

6. The circuit of claim 5, wherein the multiplexers include a first multiplexer coupled to receive the delayed input coefficient and the input coefficient.

7. The circuit of claim 6, wherein the multiplexers include a second multiplexer coupled to receive the modular difference and a second input coefficient of the input coefficients.

8. The circuit of claim 7, wherein the multiplexers include a third multiplexer coupled to receive the twiddle factor and the delayed twiddle factor.

9. The circuit of claim 8, wherein the multiplexers include a fourth multiplexer coupled to receive output of the second modular subtractor and output of the modular reduction operator.

10. The circuit of claim 9, wherein the multiplexers include a fifth multiplexer coupled to receive the modular sum and the modular sum delayed by a fourth bank of flip flops.

11. The circuit of claim 5, further comprising a divide by two operator coupled to receive the modular difference, generate a quotient that is the modular difference divided by two, and provide the quotient to the modular reduction operator.

12. The circuit of claim 1, wherein the control signal further selects whether the multiplexers are in point-wise multiplication (PWM), point-wise addition (PWA), and point-wise subtraction (PWS) mode.

13. A method for operating a reconfigurable butterfly operator circuit, the method comprising:
providing, by a first modular subtractor and based on input coefficients, a modular difference;
providing, by a single multiplier and based on a first variable and a twiddle factor, a product;
receiving, by a second modular subtractor coupled to the multiplier, the product;
providing, by a modular adder and based on the input coefficients, a modular sum;
providing, by one or more multiplexers of the multiplexers, the input coefficients to the modular adder;
providing, by one or more of the multiplexers, the twiddle factor and the first variable to the multiplier; and
receiving, by each of the multiplexers, a control signal that selects whether the reconfigurable butterfly operator circuit is configured as a Gentleman-Sande (GS) butterfly operator circuit or a Cooley-Tukey (CT) butterfly operator circuit.

14. The method of claim 13, further comprising delaying, by a first bank of flip flops connected in series with each other, an input coefficient of the input coefficients.

15. The method of claim 14, further comprising delaying, by a second bank of flip flops connected in series of with each other, the modular sum.

16. The method of claim 13, further comprising providing, by a divide by two operator coupled to receive the modular difference, a quotient that is the modular difference divided by two to a modular reduction operator.

17. The method of claim 13, wherein the control signal further selects whether the multiplexers are in point-wise multiplication (PWM), point-wise addition (PWA), and point-wise subtraction (PWS) mode.

18. A reconfigurable butterfly operator circuit comprising:
a first modular subtractor coupled to receive input coefficients and provide a first modular difference;
a single multiplier configured to receive a first variable and a twiddle factor and produce a product;
a first bank of flip flops connected in series with each other, the first bank of flip flops coupled to delay a first input coefficient of the input coefficients;
a second modular subtractor coupled to receive the product and the first input coefficient and provide a second modular difference;
a modular adder coupled to receive the input coefficients and provide a modular sum;
a second bank of flip flops connected in series of with each other, the second bank of flip flops coupled to delay the modular sum; and
multiplexers coupled to (i) provide the input coefficients to the modular adder, (ii) provide the first variable and the twiddle factor to the multiplier, (iii) and receive the modular difference from the first modular subtractor, respectively, each of the multiplexers coupled to receive a control signal that selects whether the reconfigurable butterfly operator circuit is configured as a Gentleman-Sande (GS) butterfly operator circuit or a Cooley-Tukey (CT) butterfly operator circuit.

19. The circuit of claim 18, further comprising a divide by two operator coupled to receive the modular difference, generate a quotient that is the modular difference divided by two, and provide the quotient to a modular reduction operator.

20. The circuit of claim 18, wherein the control signal further selects whether the multiplexers are in point-wise multiplication (PWM), point-wise addition (PWA), and point-wise subtraction (PWS) mode.
